(19) United States
(12) Patent Application Publication
(10) Pub. No.: US 2011/0219562 A1
(43) Pub. Date: Sep. 15, 2011

(54) CONNECTION DEVICE FOR THE ARTICULATED CONNECTION OF A WIPER BLADE

(75) Inventor: Inigo Op't Roodt, Hasselt (BE)

(73) Assignee: ROBERT BOSCH GMBH, Stuttgart (DE)

(21) Appl. No.: 13/119,995

(22) PCT Filed: Aug. 7, 2009
(86) PCT No.: PCT/EP2009/060276

§ 371 Date: May 26, 2011

(30) Foreign Application Priority Data
Sep. 19, 2008 (DE) 10 2008 042 236.3

(51) Int. Cl. B60S 1/40

(52) U.S. Cl. 15/250.32

(57) ABSTRACT

The invention relates to a connection device (10) for the articulated connection of a wiper blade (28) of flat bar construction to a wiper arm (12), which comprises a hook-shaped end (14) having a first leg (16), which is arranged toward the wiper arm (12) and which is connected to a second leg (18) through a bend (20), wherein a connection element (36) is fastened to the wiper blade (28). Said connection element is connected in an articulated manner to an adapter (62), which in turn can be connected to the hook-shaped end (14) of the wiper arm (12) and comprises contact surfaces (72) for the first and second legs (16, 18) and the bend (20) of the hook-shaped end (14) on outward facing sides. It is proposed that the adapter (62) comprises a first side wall (64) and a second side wall (66), which are connected through a front wall (70) in the manner of a horseshoe, wherein the contact surfaces (72) for the hook-shaped end (14) are arranged on the outsides of the side walls (64, 66) and of the front wall (70) and extend approximately in the direction of a vertical axis (92) of the wiper blade (28).

### BACKGROUND OF THE INVENTION

The invention is based on a connection device.

DE 20 2005 021 307 U1 discloses a connection device of the type in question. Said connection device comprises a connection element which is fixedly connected to the wiper blade, and an adapter which is fitted in a customary manner to a hook-shaped end of a wiper arm. The adapter is connected in an articulated manner to the connection element via bearing elements in the form of bearing journals on the connecting element and open hubs on the adapter. The connection element itself comprises two parts, specifically a “joining support” which is connected to the wiper blade and to which a connector bearing the bearing journals is fastened.

### SUMMARY OF THE INVENTION

According to the invention, the adapter has a first side wall and a second side wall which are connected via an end wall in a horseshoe-shaped manner. The contact surfaces for the hook-shaped end are arranged on the outer sides of the side walls and of the end wall and run approximately in the direction of a vertical axis of the wiper blade. This results in a flat construction of the connection device with little outlay on construction. Furthermore, the connection device is very well suited to absorbing torques about the longitudinal axis of the wiper blade.

According to a refinement of the invention, the adapter has bearing elements on the inner sides of the side walls thereof, said bearing elements, in the fitted state, engaging in corresponding bearing elements of the connection element and forming a pivot axis transversely with respect to the longitudinal direction of the wiper blade. The bearing elements on the adapter may be, for example, bearing journals while the corresponding bearing elements on the connection element may be designed as bearing eyes.

The connection device is suitable in particular for connection elements which are divided in a longitudinal center plane, wherein the subsections, on the mutually facing longitudinal sides, have longitudinal ribs which, in the fitted state, bear against one another and are surrounded and held together by the side walls of the adapter. Therefore, in principle, no additional holding means are required for the easily fittable subsections of the connection element, particularly since the holding together of the subsections is reinforced by the hook-shaped end of the subsequently fitted wiper arm.

To secure the adapter in the hook-shaped end of the wiper arm, the adapter has at least one I-shaped locking groove in each of the outer sides of the side walls thereof, into which of the hook-shaped end corresponding cams on the inner sides of the hook-shaped end engage in the locking grooves. In this case, during installation, each cam is initially pushed into a locking groove limb running in the direction of the vertical axis of the adapter while the adapter is subsequently displaced in the longitudinal direction of the wiper arm such that the cams pass into the other locking groove limb which is directed in the longitudinal direction of the wiper blade toward the wiper arm.

In the fitted position, the adapter is latched to the hooked-shaped end of the wiper arm. For this purpose, use is made, according to a refinement of the invention, of a spring tongue which acts counter to the direction of the vertical axis, protrudes laterally on a side wall of the adapter and has a latching cam. In the fitted state, the latter engages in a corresponding notch in the hook-shaped end. The spring tongue is advantageously formed from a part of a side wall, the majority of which part is separated from the remaining side wall by a gap. In order to release the latching, the free end of the spring tongue has a button. The latter bounds an intermediate space in the longitudinal direction together with the latching cam, said intermediate space providing space for a section of the hook-shaped end located between the notch and the free end.

Furthermore, it may be advantageous for the spring tongue to be guided in the flexible movement thereof. For this purpose, use is made of a recess on that side of the spring tongue which faces the gap. A corresponding stud of the side wall engages in said recess with an appropriate amount of play.

### BRIEF DESCRIPTION OF THE DRAWINGS

Further advantages emerge from the description below of the drawing. The drawing illustrates an exemplary embodiment of the invention. The drawing, the description and the claims contain numerous features in combination. A person skilled in the art will expediently also consider the features individually and put them together to form meaningful further combinations.

In the drawing:

FIG. 1 shows a perspective view of a wiper blade with a connection device according to the invention and a wiper arm,

FIG. 2 shows a perspective partial view during the installation of the wiper blade on the wiper arm,

FIG. 3 shows a perspective partial view upon installation of an adapter on a connection element, and

FIG. 4 shows an enlarged perspective view of an adapter.

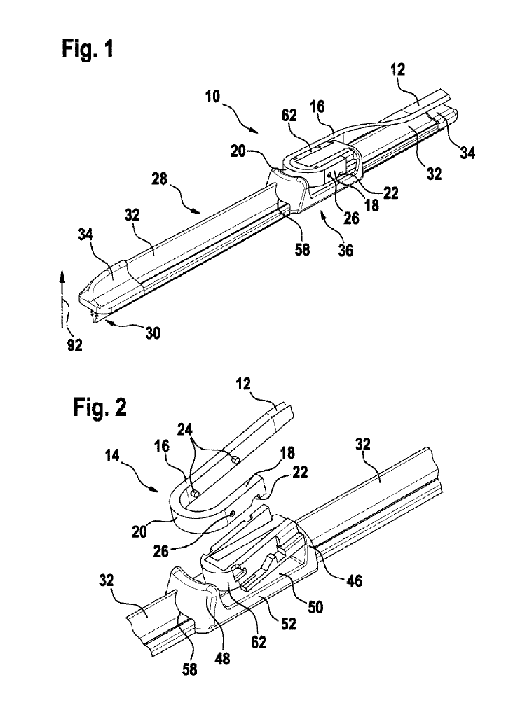

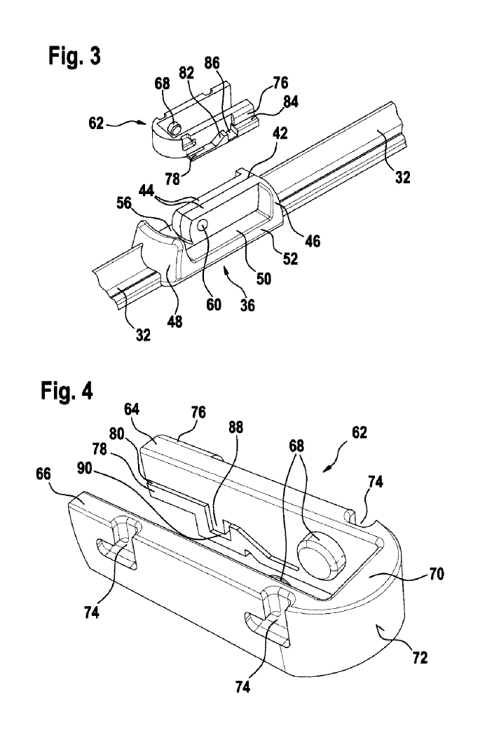

### DETAILED DESCRIPTION

FIG. 1 shows a wiper blade 28 of flat bar construction, which, in a central region, has a connection device 10 for the articulated connection to a wiper arm 12. In the longitudinal direction on both sides of the connection device 10, spoiler parts 32 are fastened to a supporting element (not visible), as is known in wiper blades of this type. The supporting element furthermore bears a wiper strip 30 for cleaning a vehicle window (not illustrated). The wiper blade 28 bears end caps 34 at the ends thereof.

The connection device 10 comprises a two-part connection element 36 and an adapter 62. The connection element 36 has a first subsection 38 and a second subsection 40 which, on the mutually facing sides, have longitudinal ribs 44 which bear against one another and form a separating joint 42. The longitudinal ribs 44 end in the longitudinal direction at a distance from a front end wall 48 and form an intermediate space 56 with the latter. Said intermediate space serves to receive an end wall 70 of the adapter 62 and a bend 20 of a hook-shaped end 14 of a wiper arm 12. The inner side of the front end wall 48 is curved concavely corresponding to the outer circumferential surface of the bend 20 in order to provide a clearance for a pivoting movement. The subsections 38, 40 of the connection element 36 are bounded by a further end wall 46 toward the driving end. The end walls 46, 48, which have connection profiles 58 for transition to the spoiler parts 32, and the longitudinal ribs 44 are integrally formed on a base 50 and are produced from plastic, for example, in an injection molding process. The base 50 together with side walls 52 surrounds the supporting element of the wiper blade 28.

The adapter 62 has a horseshoe-shaped design, in which the end wall 70 connects a first side wall 64 to a second side wall 66. The outer sides of the side walls 64, 66 and of the end wall 70 have contact surfaces 72 which run in the direction of a vertical axis 92 of the wiper blade 28. In this case, the contact surface 72 in the region of the end wall is curved convexly corresponding to the inner surface of the bend 20 of the hook-shaped end 14 such that the hook-shaped end 14 bears tightly against the contact surface 72 in the fitted state. The two side walls 64, 66 and the end wall 70 enclose an interior space which is open on the side opposite the end wall 70. Mutually facing bearing elements in the form of bearing journals 68 are provided on the inner sides of the side walls 64, 66. Said bearing elements engage in corresponding bearing elements on the longitudinal ribs 44 of the connection element 36, which bearing elements are designed in the form of bearing eyes 60. The bearing journals 68 and the bearing eyes 60 form a pivot axis running transversely with respect to the wiper blade 28 such that, in the fitted state, the wiper arm 12 is connected pivotably to the wiper blade 28.

The hook-shaped end 14 of the wiper arm 12 has a first limb 16 in an extension of the wiper arm 12, said limb being connected to a second limb 18 via the bend 20. Two cams 24 are arranged on the inner side of the first limb 16 while only one cam 24 is provided on the second limb 18 toward the bend 20. The cams 24 are expediently formed by pressing out of the material of the wiper arm 12 without cutting, and corresponding depressions 26 are produced on the outer side of the limbs 16, 18.

The hook-shaped end 14 is held on the adapter 62 in L-shaped locking grooves 74 on the outer sides of the side walls 64 by means of the cams 24. In this case, one limb of the locking grooves runs approximately in the direction of the vertical axis 92 while the other limb is directed in the longitudinal direction toward the driving end of the wiper blade 28. The cams 24 and the L-shaped locking grooves 74 are arranged in such a manner that the hook-shaped end 14 can first of all be threaded into the locking groove 74 in the direction of the vertical axis 92 and, after reaching the other limb in the locking groove 74, can be displaced in the longitudinal direction of the adapter 62. As a result, the hook-shaped end 14 is blocked in the direction of the vertical axis.

On the first side wall 64 thereof, against which the second limb 18 of the hook-shaped end 14 bears, the adapter 62 has only one locking groove 74 which is arranged toward the end wall 70. The first side wall 64 has a laterally outwardly protruding spring tongue 78 with a latching cam 82. If, during installation into the hook-shaped end 14 of the wiper arm 12, the adapter 62 is displaced in the longitudinal direction to the free end of the wiper arm 12, a notch 22 at the free end of the second limb 18 latches on the latching cam 82. The spring tongue 78 is extended beyond the latching cam 82 and is provided at this end with a button 84. By actuation of the button 84 in the opposite direction to the vertical axis 92, the latching cam 82 moves out of the notch 22 such that the latching connection is released. An intermediate space 86 for the end of the second limb 18 which protrudes over the notch 22 is provided between the latching cam 82 and the button 84.

The spring tongue 78 is expediently formed from a part of the first side wall 64 by being separated, apart from a small residue, from the rest of the side wall 64 by a gap 80. A thickened portion 76 on the outer side of the first side wall 64 serves as a stop in the region of the button 84. Furthermore, in the region of the intermediate space 86, the spring tongue 78 has a recess 90 in which a stud 88 of the first side wall 64 engages. The stud 88 can serve to guide the spring tongue 78 relative to the side wall 64.

1. A connection device (10) for the articulated connection of a wiper blade (28) of flat bar construction to a wiper arm (12) which has a hook-shaped end (14) with a first limb (16) which is arranged toward the wiper arm (12) and is connected to a second limb (18) via a bend (20), wherein a connection element (36) is fastened to the wiper blade (28) and is connected in an articulated manner to an adapter (62) configured to be connected to the hook-shaped end (14) of the wiper arm (12) and the adaptor having, on outwardly facing sides, contact surfaces (72) for the first and second limbs (16, 18) and for the bend (20) of the hook-shaped end (14), characterized in that the adapter (62) has a first side wall (64) and a second side wall (66) which are connected via an end wall (70) in the manner of a horseshoe, the contact surfaces (72) for the hook-shaped end (14) being arranged on outer sides of the side walls (64, 66) and of the end wall (70) and running approximately in the direction of a vertical axis (92) of the wiper blade (28).

2. The connection device (10) as claimed in claim 1, characterized in that the adapter (62) has bearing elements (68) on inner sides of the side walls (64, 66) thereof, said bearing elements, in fitted state, engaging in corresponding bearing elements (60) of the connection element (36) and forming a pixot axis transversely with respect to a longitudinal direction of the wiper blade (28).

3. The connection device (10) as claimed in claim 2, characterized in that the connection element (36) has a first and second subsection which, on mutually facing longitudinal sides, have longitudinal ribs (44) which, in the fitted state, bear against one another and are surrounded and held together by the side walls (64, 66) of the adapter (62).

4. The connection device (10) as claimed in claim 1, characterized in that the adapter (62) has at least one L-shaped locking groove (74) in each of the outer sides of the side walls (64, 66) thereof, one limb of the locking groove (74) pointing in the direction of the vertical axis (92) and the other limb being directed in a longitudinal direction of the wiper blade (28) toward the wiper arm (12).

5. The connection device (10) as claimed in claim 1, characterized in that the adapter (62) has a spring tongue (78) which protrudes laterally on a side wall (64, 66), acts counter to the direction of the vertical axis (92) and has a latching cam (82) which, in a fitted state, is configured to engage in a corresponding notch (22) in the hook-shaped end (14) of the wiper arm (12).

6. The connection device (10) as claimed in claim 5, characterized in that the spring tongue (78) is formed from a part of a side wall (64, 66), the majority of which part is separated from the remaining side wall (64, 66) by a gap (80).

7. The connection device (10) as claimed in claim 5, characterized in that a free end of the spring tongue (78) has a button (84) which bounds an intermediate space (86) in a longitudinal direction together with the latching cam (82).

8. The connection device (10) as claimed in claim 6, characterized in that a side of the spring tongue (78) which faces the gap (80) has a recess (90) in which a stud (88) of the side wall (64, 66) engages.

9. A wiper blade comprising a connection device (10) for the articulated connection of the wiper blade (28) to a wiper arm (12) which has a hook-shaped end (14) with a first limb (16) which is arranged toward the wiper arm (12) and is connected to a second limb (18) via a bend (20), wherein a connection element (36) is fastened to the wiper blade (28) and is connected in an articulated manner to an adapter (62) configured to be connected to the hook-shaped end (14) of the wiper arm (12) and the adaptor having, on outwardly facing sides, contact surfaces (72) for the first and second limbs (16, 18) and for the bend (20) of the hook-shaped end (14), characterized in that the adapter (62) has a first side wall (64) and a second side wall (66) which are connected via an end wall (70) in the manner of a horseshoe, the contact surfaces (72) for the hook-shaped end (14) being arranged on outer sides of the side walls (64, 66) and of the end wall (70) and running approximately in the direction of a vertical axis (92) of the wiper blade (28).

10. A wiper arm (12) with a hook-shaped end (14) which is formed by a first limb (16) and a second limb (18), which are connected to each other by a bend (20), and, in a fitted state, bears with inner sides thereof against contact surfaces (72) of an adapter (62), and a connection device (10) for the articulated connection of the wiper blade (28) to the wiper arm (12), wherein a connection element (36) is fastened to the wiper blade (28) and is connected in an articulated manner to the adapter (62), characterized in that the adapter (62) has a first side wall (64) and a second side wall (66) which are connected via an end wall (70) in the manner of a horseshoe, the contact surfaces (72) for the hook-shaped end (14) being arranged on outer sides of the side walls (64, 66) and of the end wall (70) and running approximately in the direction of a vertical axis (92) of the wiper blade (28), and the inner sides of the hook-shaped end (14) run in the direction of the vertical axis (92).

11. The wiper arm (12) as claimed in claim 10, characterized in that the inner sides of the hook-shaped end (14) have cams (24) which match locking grooves (74) of the adapter (62).

12. The wiper arm (12) as claimed in claim 10, characterized in that a notch (22) which matches a latching cam (82) of the adapter (62) is provided in a side of the hook-shaped end (14) which faces the wiper strip (30).

13. The connection device (10) as claimed in claim 3, characterized in that the adapter (62) has at least one L-shaped locking groove (74) in each of the outer sides of the side walls (64, 66) thereof, one limb of the locking groove (74) pointing in the direction of the vertical axis (92) and the other limb being directed in a longitudinal direction of the wiper blade (28) toward the wiper arm (12).

14. The connection device (10) as claimed in claim 13, characterized in that the adapter (62) has a spring tongue (78) which protrudes laterally on a side wall (64, 66), acts counter to the direction of the vertical axis (92) and has a latching cam (82) which, in a fitted state, is configured to engage in a corresponding notch (22) in the hook-shaped end (14) of the wiper arm (12).

15. The connection device (10) as claimed in claim 14, characterized in that the spring tongue (78) is formed from a part of a side wall (64, 66), the majority of which part is separated from the remaining side wall (64, 66) by a gap (80).

16. The connection device (10) as claimed in claim 15, characterized in that a free end of the spring tongue (78) has a button (84) which bounds an intermediate space (86) in a longitudinal direction together with the latching cam (82).

17. The connection device (10) as claimed in claim 16, characterized in that a side of the spring tongue (78) which faces the gap (80) has a recess (90) in which a stud (88) of the side wall (64, 66) engages.
